(19) United States
(12) Patent Application Publication
(10) Pub. No.: US 2025/0308803 A1
(43) Pub. Date: Oct. 2, 2025

(54) LAMINATED CERAMIC ELECTRONIC COMPONENT AND METHOD FOR MANUFACTURING LAMINATED CERAMIC ELECTRONIC COMPONENT

(71) Applicant: TAIYO YUDEN CO., LTD., Tokyo (JP)

(72) Inventors: Michio OSHIMA, Tokyo (JP); Hakuo KATAOKA, Tokyo (JP); Masaki SAITO, Tokyo (JP); Takuya ENOMOTO, Tokyo (JP); Yuji TAKITA, Tokyo (JP); Yusuke TOYA, Tokyo (JP)

(73) Assignee: TAIYO YUDEN CO., LTD., Tokyo (JP)

(21) Appl. No.: 19/084,707

(22) Filed: Mar. 19, 2025

(30) Foreign Application Priority Data
Mar. 29, 2024 (JP) 2024-056719

(51) Int. Cl. H01G 4/30; H01G 4/012; H01G 4/12

(52) U.S. Cl. CPC H01G 4/30; H01G 4/012; H01G 4/12

(57) ABSTRACT

A laminated ceramic electronic component includes: a laminated portion, a pair of cover portions facing each with the laminated portion therebetween, and a pair of external electrodes. The laminated portion has a capacitance forming portion having a plurality of ceramic layers and internal electrodes, and a pair of internal electrode lead-out regions between the pair of cover portions. The capacitance forming portion is between internal electrode lead-out regions. A pair of margin regions are between the pair of cover portions. The cover portion has a central region adjacent to the capacitance forming portion having a first density, and a peripheral edge region surrounding the central region having a second density, wherein the internal electrode lead-out region has a third density and the margin region has a fourth density. At least one of the second density, the third density, and the fourth density is less than the first density.

### CROSS-REFERENCE TO RELATED APPLICATION(S)

This application is based upon and claims the benefit of priority from Japanese Patent Application No. JP2024-056719, filed Mar. 29, 2024, the entire contents of which are incorporated herein by reference.

### BACKGROUND

### 1. Technical Field

The present disclosure relates to a laminated ceramic electronic component and a method for manufacturing a laminated ceramic electronic component.

### 2. Description of the Related Art

With reduction in size and improvement in functionality of electronic devices, it is required to reduce the size of electronic components used in the electronic devices. However, when the electronic components are reduced in size while maintaining the conventional structure, resistance to bending cracks tends to decrease. For example, in a small low-capacitance capacitor, it is difficult to prevent bending cracks from entering a capacitance acquisition area.

In order to prevent such cracks or the like, JP 2013-191833 A and JP 2015-23270 A disclose a technique of, even if a crack occurs, preventing the crack from reaching a capacitance portion by limiting an area of the capacitance portion.

### SUMMARY

In the conventional techniques, a range in which a capacitance can be realized is limited. Thus, realizing both reduction in size of components and an increase in capacitance is difficult.

The present disclosure is directed to providing a laminated ceramic electronic component capable of securing a capacitance portion while suppressing a structural defect in the capacitance portion.

A laminated ceramic electronic component according to an aspect of the present disclosure includes: a laminated portion including a plurality of first ceramic layers laminated in a first direction, a plurality of internal electrodes alternately led out and arranged in a second direction orthogonal to the first direction, a non-electrode formation region where no internal electrode between the plurality of first ceramic layers, and a plurality of second ceramic layers laminated in the non-electrode formation region between the plurality of first ceramic layers; a pair of cover portions facing each other in the first direction with the laminated portion interposed between the cover portions; and a pair of external electrodes connected to the plurality of internal electrodes and facing each other in the second direction. The laminated portion has a capacitance forming portion in which the plurality of internal electrodes is laminated in the first direction via the first ceramic layers, a pair of internal electrode lead-out regions between the pair of cover portions, in which the first ceramic layers, the internal electrodes, and internal lead-out regions layers are laminated in the first direction, wherein the pair of internal electrode lead-out regions face each other in the second direction with the capacitance forming portion between the internal electrode lead-out regions along the second direction, and a pair of margin regions between the pair of cover portions, wherein the pair of margin regions face each other in a third direction orthogonal to the first direction and the second direction with the capacitance forming portion and the internal electrode lead-out regions between the margin regions along the third direction. The cover portion has a central region having a first density adjacent to the capacitance forming portion, and a peripheral edge region having a second density surrounding the central region, wherein the internal electrode lead-out region has a third density and the margin region has a fourth density, and at least one of the second density, the third density, and the fourth density is less than the first density.

According to the present disclosure, in a laminated ceramic electronic component, a capacitance portion while suppressing a structural defect in the capacitance portion.

### BRIEF DESCRIPTION OF THE DRAWINGS

FIG. 1 shows an example of a laminated ceramic electronic component according to a first embodiment;

FIG. 2 is a cross-sectional view taken along line I-I in FIG. 1;

FIG. 3 is a cross-sectional view taken along line II-II in FIG. 1;

FIG. 4 is a schematic view of a laminated portion in FIG. 2;

FIG. 5 is a perspective view showing a laminated portion in FIG. 4;

FIG. 6 shows an effect of the laminated ceramic electronic component according to the first embodiment;

FIG. 7 is a flowchart showing a method for manufacturing a laminated ceramic electronic component;

FIG. 8 is a cross-sectional view of an example of a laminated ceramic electronic component according to a second embodiment and is a view corresponding to FIG. 2;

FIG. 9 is a cross-sectional view of an example of the laminated ceramic electronic component according to the second embodiment and is a view corresponding to FIG. 3; and

FIG. 10 shows an effect of the laminated ceramic electronic component according to the second embodiment.

### DETAILED DESCRIPTION

Hereinafter, embodiments will be described in detail, but the present disclosure is not limited thereto. In the present specification and the drawings, components having substantially the same functional configuration will be denoted by the same reference signs, and description thereof will be omitted in some cases. The scale of each member in each drawing may be different from its actual scale.

In the following description, an XYZ orthogonal coordinate system will be used, but the coordinate system is defined for the sake of description and does not limit an orientation of a laminated ceramic electronic component. In the present specification, the X-axis direction, the Y-axis direction, and the Z-axis direction correspond to a second direction, a third direction, and a first direction, respectively, in the laminated ceramic electronic component of the present disclosure.

### First Embodiment

### [Configuration of Laminated Ceramic Electronic Component]

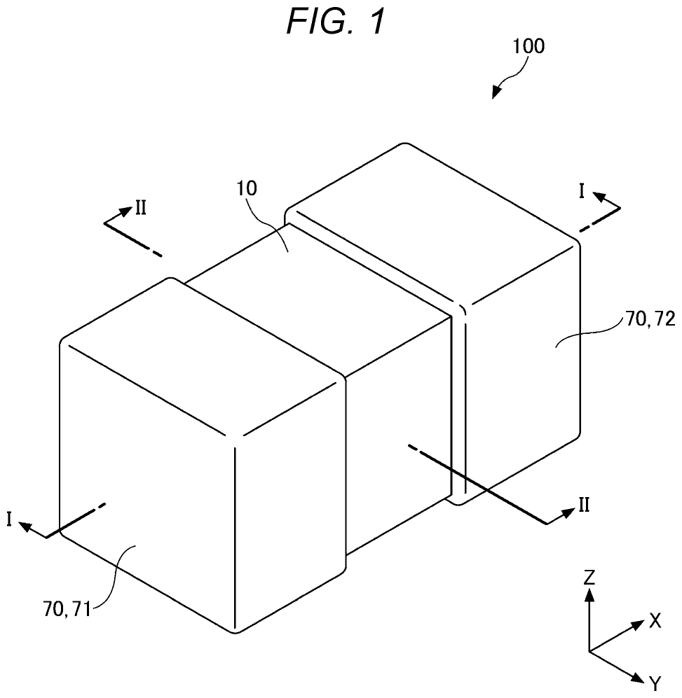

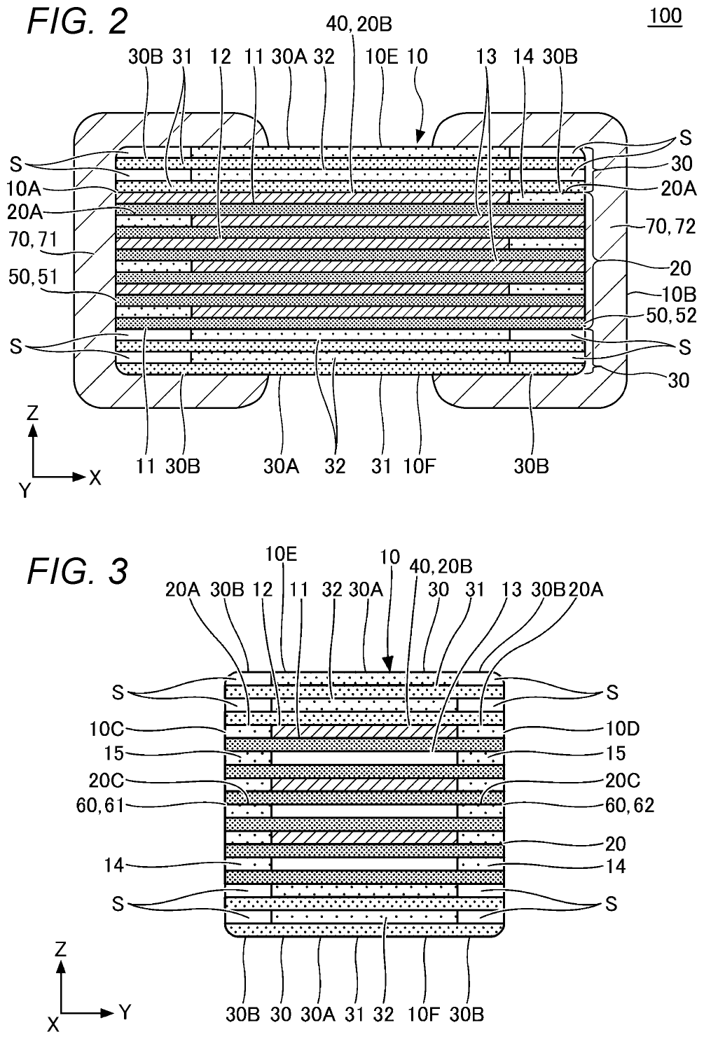

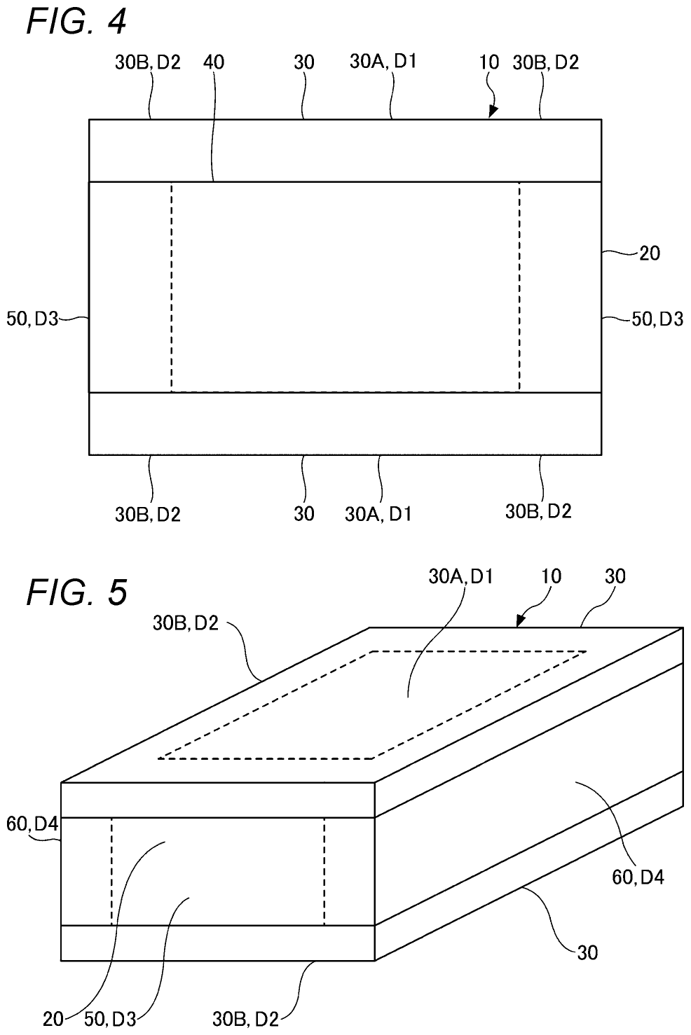

FIG. 1 shows a laminated ceramic capacitor as an example of a laminated ceramic electronic component according to a first embodiment. FIG. 2 is a cross-sectional view taken along line I-I in FIG. 1. FIG. 3 is a cross-sectional view taken along line II-II in FIG. 1. FIG. 4 is a schematic view of a laminated portion in FIG. 2. FIG. 5 is a perspective view showing the laminated portion in FIG. 4.

A laminated ceramic capacitor 100 in FIGS. 1 to 3 is an example of the laminated ceramic electronic component of the present disclosure. The laminated ceramic capacitor 100 includes a ceramic body 10 and a pair of external electrodes 70. The external electrodes 70 include a first external electrode 71 and a second external electrode 72.

The ceramic body 10 has two end surfaces 10A and 10B facing in the X-axis direction, two side surfaces 10C and 10D facing in the Y-axis direction, and two principal surfaces 10E and 10F facing in the Z-axis direction. Ridges connecting the surfaces of the ceramic body 10 may be rounded. The shape of the ceramic body 10 is not limited to the above and may not be a rectangular parallelepiped shape as shown in FIGS. 1 to 3.

The first external electrode 71 and the second external electrode 72 face each other in the X-axis direction so as to cover the end surfaces 10A and 10B of the ceramic body 10, respectively. The external electrodes 71 and 72 extend to four surfaces (two side surfaces 10C and 10D and two principal surfaces 10E and 10F) connected to the end surfaces 10A and 10B. Therefore, in both the external electrodes 71 and 72, a cross section parallel to the X-Z plane and a cross section parallel to the X-Y plane are U-shaped. The shape of the external electrodes 70 is not limited to the example in FIG. 2.

The external electrodes 70 may have a base film (not shown) formed to cover the end surfaces 10A and 10B and a plated film (not shown) formed on the base film. The base film includes, for example, a baked film obtained by firing a conductive paste, a sputtered film, or the like. The plated film is a film formed by electrolytic plating.

The external electrodes 70 are made from a good electrical conductor. Examples of the good electrical conductor made into the external electrodes 70 include metals or alloys containing copper (Cu), nickel (Ni), tin (Sn), palladium (Pd), platinum (Pt), silver (Ag), gold (Au), or the like as a main component. In the present embodiment, the main component refers to a component having the highest content ratio.

The ceramic body 10 has a laminated portion 20 and a pair of cover portions 30. The laminated portion 20 includes a plurality of ceramic layers 11 laminated in the Z-axis direction and first internal electrodes 12 and second internal electrodes 13 alternately arranged between the plurality of ceramic layers 11. The ceramic layers 11 are an example of first ceramic layers in the laminated ceramic electronic component of the present disclosure.

The ceramic layers 11 are arranged between the internal electrodes 12 and 13 and are made from insulating ceramics. The ceramic layers 11 may be made from insulating ceramics having high permittivity in order to increase a capacitance in a capacitance forming portion described later.

As the insulating ceramics having high permittivity, for example, a perovskite structure material containing barium (Ba) and titanium (Ti), which is represented by barium titanate (BaTiO₃), is used. Thus, the laminated ceramic capacitor 100 having a large capacitance is obtained.

The ceramic layers 11 may be made from, for example, strontium titanate (SrTiO₃)-based, calcium titanate (CaTiO₃)-based, magnesium titanate (MgTiO₃)-based, calcium zirconate (CaZrO₃)-based, calcium zirconate titanate (Ca(Zr,Ti)O₃)-based, barium zirconate (BaZrO₃)-based, or titanium oxide (TiO₂)-based material.

The internal electrodes 12 and 13 are made from a good electrical conductor. The good electrical conductor made into the internal electrodes 12 and 13 is made from nickel (Ni) as a main component and functions as internal electrodes of the laminated ceramic capacitor 100. The internal electrodes 12 and 13 may contain at least one of copper (Cu), silver (Ag), and palladium (Pd) as a main component in addition to nickel.

The cover portions 30 face each other with the laminated portion 20 interposed therebetween in the Z-axis direction. That is, the cover portions 30 cover an upper surface and a lower surface of the laminated portion 20 in the Z-axis direction. The cover portions 30 secure insulation in the Z-axis direction of a capacitance forming portion 40 described later and protects the capacitance forming portion 40.

In the present disclosure, the cover portions 30 include a plurality of ceramic layers 31 laminated in the Z-axis direction. The ceramic layers 31 are an example of third ceramic layers in the laminated ceramic electronic component of the present disclosure. The ceramic layers are made from insulating ceramics. A material for forming the cover portions 30 only needs to be insulating ceramics, but using insulating ceramics similar to those of the ceramic layers 11 suppresses the internal stress in the ceramic body 10.

The internal electrodes 12 and 13 are alternately led out and arranged in the Y-axis direction while non-electrode formation regions 20A where no internal electrode exists are left between the plurality of ceramic layers 11. That is, the internal electrodes 12 and 13 are not arranged in the non-electrode formation regions 20A between the plurality of ceramic layers 11. The internal electrodes 12 and 13 are arranged, and the non-electrode formation regions 20A form gaps S.

In the present disclosure, the first internal electrodes 12 are connected to the first external electrode 71 by being led out to the end surface 10A and are separated from the second external electrode 72. The second internal electrodes 13 are connected to the second external electrode 72 by being led out to the end surface 10B and are separated from the first external electrode 71. The internal electrodes 12 and 13 are not led out to the side surfaces 10C and 10D.

Further, ceramic layers 14 are laminated in the non-electrode formation regions 20A between the plurality of ceramic layers 11. The ceramic layers 14 can serve as step absorbing layers that fill steps between the ceramic layers 11 and the internal electrodes 12 and 13 with the non-electrode formation regions 20A. The ceramic layers 14 are an example of second ceramic layers in the laminated ceramic electronic component of the present disclosure.

Thus, the capacitance forming portion 40 is formed in an electrode laminated region 20B where the internal electrodes 12 and 13 are laminated in the Z-axis direction with the ceramic layers 11 interposed therebetween in the laminated portion 20. That is, the laminated portion 20 includes the capacitance forming portion 40.

In the capacitance forming portion 40, when a voltage is applied between the first external electrode 71 and the second external electrode 72, a voltage is applied to the plurality of ceramic layers 11 between the first internal electrodes 12 and the second internal electrodes 13. Thus, charges corresponding to the voltage between the first external electrode 71 and the second external electrode 72 are stored in the laminated ceramic capacitor 100.

A pair of internal electrode lead-out regions 50 facing each other with the capacitance forming portion 40 interposed therebetween in the X-axis direction is formed on the side of the end surfaces 10A and 10B of the laminated portion 20. The internal electrode lead-out regions 50 include a first internal electrode lead-out region 51 and a second internal electrode lead-out region 52. The pair of internal electrode lead-out regions 50 is arranged between the pair of cover portions 30.

The first internal electrode lead-out region 51 is formed by laminating the plurality of ceramic layers 11, the plurality of first internal electrodes 12, and the plurality of ceramic layers 14 in the Z-axis direction. The second internal electrode lead-out region 52 is formed by laminating the plurality of ceramic layers 11, the plurality of second internal electrodes 13, and the ceramic layers 14 in the Z-axis direction. That is, the laminated portion 20 has the pair of internal electrode lead-out regions 50.

The pair of margin regions 60 is formed on the side of the side surfaces 10C and 10D of the laminated portion 20 to cover the capacitance forming portion 40 and side surfaces of the pair of internal electrode lead-out regions 50 in the Y-axis direction.

The margin regions 60 include a first margin region 61 and a second margin region 62. The pair of margin regions 60 is arranged between the pair of cover portions 30. The margin regions 60 are formed by alternately laminating the plurality of ceramic layers 11 and the plurality of ceramic layers 14 in the Z-axis direction. That is, the laminated portion 20 has the pair of margin regions 60.

As shown in FIG. 3, the margin regions 60 have step regions 20C forming steps with the internal electrodes 12 and 13 between the plurality of ceramic layers 11. The step regions 20C are formed in a state in which the internal electrodes 12 and 13 are arranged between the plurality of ceramic layers 11. In the margin regions 60, ceramic layers 15 are arranged in the step regions 20C.

In the laminated ceramic capacitor 100 of the present disclosure, as shown in FIGS. 4 and 5, when the density of a central region 30A of the cover portion 30 is defined as a first density D1, and the density of a peripheral edge region 30B of the cover portion 30 is defined as a second density D2, the second density D2 is smaller than the first density D1.

As shown in FIGS. 4 and 5, the central region 30A of the cover portion 30 is adjacent to the capacitance forming portion 40 in the laminated portion 20. For example, the central region 30A may overlap the capacitance forming portion 40 along the Z-axis in both the Z-X and Z-Y cross-sections. As shown in FIGS. 4 and 5, the peripheral edge region 30B of the cover portion 30 surrounds the central region 30A.

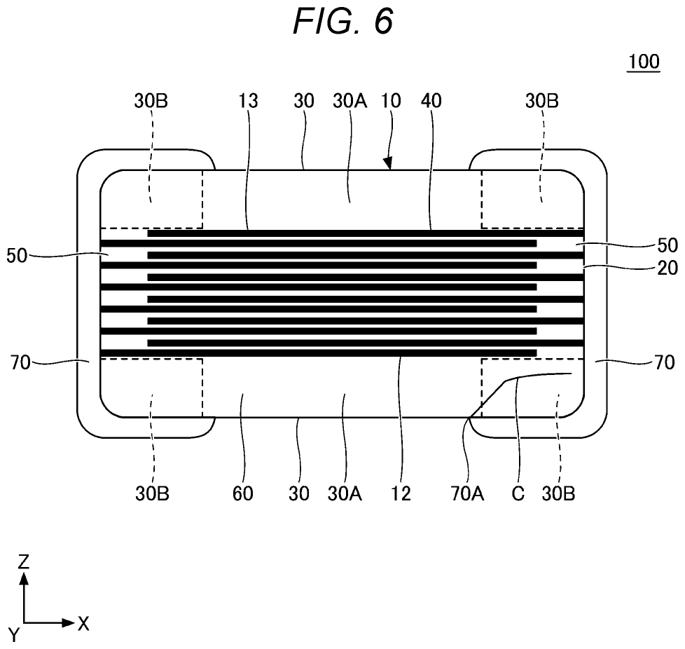

FIG. 6 shows an effect of the laminated ceramic electronic component according to the first embodiment. In the laminated ceramic capacitor 100 of the present disclosure, in a case where the bending stress is generated, a bending crack C tends to occur from a boundary 70A between the cover portion 30 and an end of the external electrode 70.

Meanwhile, because the second density D2 is smaller than the first density D1 in the laminated ceramic capacitor 100 of the present disclosure, the bending crack C tends to be led to the peripheral edge region 30B of the cover portion 30 having a smaller density. That is, even if the bending crack C occurs in the laminated ceramic capacitor 100, the bending crack C does not easily reach the capacitance forming portion 40 that is a capacitance acquisition area.

Therefore, the first embodiment can improve resistance to bending cracks even if the laminated ceramic electronic component is reduced in size.

In the laminated ceramic capacitor 100 of the present disclosure, the porosity of the central region 30A of the cover portion 30 is less than 2.0%, whereas the porosity of the peripheral edge region 30B of the cover portion 30 is 2.0% or more.

The porosity is calculated by the following procedure, for example. First, the cross sections of the central region 30A and the peripheral edge region 30B of the cover portion 30 are imaged at a predetermined magnification (for example, 2000 to 5000 times) by a scanning electron microscope (SEM). A plurality of parts (e.g. five parts) of the cross sections of the central region 30A and the peripheral edge region 30B are imaged. Next, cross-sectional areas of pores appearing in the images obtained by imaging the cross sections of the central region 30A and the peripheral edge region 30B are measured, and an average value of the cross-sectional areas of the pores in the central region 30A and an average value of the cross-sectional areas of the pores in the peripheral edge region 30B are calculated from the cross-sectional areas of the pores in the plurality of images. Then, the porosity in the central region 30A and the porosity in the peripheral edge region 30B are calculated from a ratio of the average value to the cross-sectional areas of the central region 30A and the peripheral edge region 30B, respectively.

In the laminated ceramic capacitor 100 of the present disclosure, the porosity of the central region 30A of the cover portion 30 is less than 2.0%, and the porosity of the peripheral edge region 30B of the cover portion 30 is 2.0% or more. Thus, the second density D2 can be made smaller than the first density D1 as described above.

In the first embodiment, as shown in FIG. 4, when the density of the internal electrode lead-out region 50 is defined as a third density D3, and the density of the margin region 60 is defined as a fourth density D4, the second density D2 is smaller than the third density D3 and/or the fourth density D4.

Specifically, the porosity of the internal electrode lead-out region 50 and/or the margin region 60 is less than 2.0%, whereas the porosity of the peripheral edge region 30B of the cover portion 30 is 2.0% or more. That is, in the first embodiment, the porosity of the peripheral edge region 30B of the cover portion 30 is smaller than the porosity of the internal electrode lead-out region 50 and/or the margin region 60.

In the laminated ceramic capacitor 100 of the present disclosure, the porosity of the peripheral edge region 30B of the cover portion 30 is smaller than the porosity of the internal electrode lead-out region 50 and/or the margin region 60, and thus the second density D2 is smaller than the third density D3 and/or the fourth density D4. This makes it possible to prevent the bending crack C from reaching the capacitance forming portion 40 that is the capacitance acquisition area and further to prevent the bending crack C from reaching the internal electrode lead-out region 50 where a lead-out portion of the internal electrode is arranged. Thus, according to the first embodiment, the resistance to bending cracks can be further improved.

In the laminated ceramic capacitor 100 of the present disclosure, the porosity of the internal electrode lead-out region 50 and/or the margin region 60 is less than 2.0%, and the porosity of the peripheral edge region 30B of the cover portion 30 is 2.0% or more, and thus the second density D2 can be made smaller than the third density D3 and/or the fourth density D4 as described above.

Further, in the present disclosure, a ratio between the Vickers hardness of the central region 30A of the cover portion 30 and the Vickers hardness of the peripheral edge region 30B of the cover portion 30 is 1.0 or more.

The Vickers hardness can be calculated, for example, by measuring the length of the diagonal line of an indentation after pressurization for 10 seconds under a load of 25 gf. A method for adjusting the Vickers hardness is not particularly limited. For example, the Vickers hardness can be adjusted by adjusting the concentration of a sintering additive contained in the cover portion 30, firing conditions, and the like.

In the laminated ceramic capacitor 100 of the present disclosure, as described above, the second density D2 can be made smaller than the first density D1 also when the ratio between the Vickers hardness of the central region 30A of the cover portion 30 and the Vickers hardness of the peripheral edge region 30B of the cover portion 30 is 1.0 or more.

In the laminated ceramic capacitor 100 of the present disclosure, a plurality of ceramic layers 32 is arranged between the plurality of ceramic layers 31 in the central region 30A of the cover portion 30. The ceramic layers 32 are an example of fourth ceramic layers in the laminated ceramic electronic component of the present disclosure. The ceramic layers 31 may include more glass components, e.g., silicon, to improve moisture resistance in the peripheral edge region 30B.

In the peripheral edge region 30B of the cover portion 30, the ceramic layers 32 are not arranged between the plurality of ceramic layers 31. In particular, a gap S is between the ceramic layers 31 in the peripheral edge region 30B along the Z-axis. In other words, the peripheral edge region 30B has less material therein than the central region 30A along the Z-axis direction. Therefore, the second density D2 of the peripheral edge region 30B of the cover portion 30 can be made smaller than the first density D1 of the central region 30A of the cover portion 30.

### [Method for Manufacturing Laminated Ceramic Electronic Component of First Embodiment]

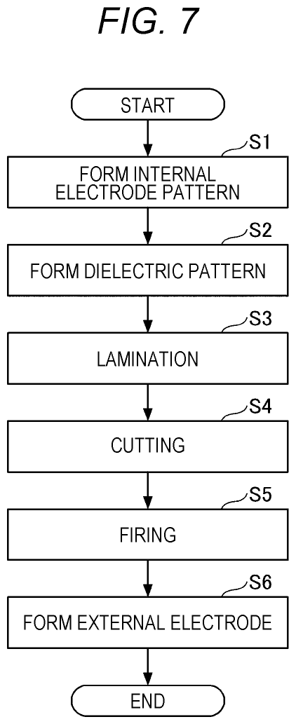

FIG. 7 is a flowchart showing a method for manufacturing the above laminated ceramic capacitor that is an example of the laminated ceramic electronic component. Hereinafter, the method for manufacturing the laminated ceramic electronic component according to the first embodiment will be described.

### (Step S1: Formation of Internal Electrode Pattern)

In step S1, internal electrode patterns for forming the internal electrodes 12 and 13 are formed on a first ceramic sheet and a second ceramic sheet for forming the laminated portion 20.

Ceramic sheets of the first ceramic sheet and the second ceramic sheet are formed as unfired dielectric green sheets containing dielectric ceramics as a main component. As the dielectric ceramics, for example, powder having the particle diameter of 20 nm to 200 nm can be used. The ceramic sheet is formed into a sheet shape by using, for example, a roll coater, a doctor blade, or the like. The thickness of the ceramic sheet is not limited, but is adjusted to, for example, 1.5 μm or less.

The ceramic sheet is first formed as a large sheet that is not divided into individual pieces. The ceramic sheet is provided with a plurality of first cutting lines and a plurality of second cutting lines used when being divided into individual laminated ceramic capacitors. The first cutting lines are parallel to the X-axis, and the second cutting lines are parallel to the Y axis.

An unfired first internal electrode pattern corresponding to the internal electrode 12 is formed on the first ceramic sheet, and an unfired second internal electrode pattern corresponding to the internal electrode 13 is formed on the second ceramic sheet.

The internal electrode pattern can be formed by applying an arbitrary conductive paste to the ceramic sheet. A method for applying the conductive paste can be arbitrarily selected from known techniques. For example, screen printing or gravure printing can be used for applying the conductive paste.

Each internal electrode pattern of the first ceramic sheet is formed in a substantially rectangular shape extending in the X-axis direction across any one of two facing second cutting lines. Each internal electrode pattern is cut by two facing second cutting lines and first cutting lines to form the internal electrode 12 of each laminated ceramic capacitor 100. The internal electrode patterns on the two facing second cutting lines correspond to lead-out portions exposed on the end surface 10A.

In the first ceramic sheet, a first row in which the first internal electrode pattern extending across the one second cutting line is arranged in the X-axis direction and a second row in which the internal electrode pattern extending across another facing second cutting line is arranged in the X-axis direction are alternately arranged in the Y-axis direction. In the first row, the internal electrode patterns adjacent to each other in the X-axis direction face each other with the another facing second cutting line interposed therebetween. In the second row, the internal electrode patterns adjacent to each other in the X-axis direction face each other with the one facing second cutting line interposed therebetween. That is, in the first row and the second row adjacent in the Y-axis direction, the internal electrode patterns are arranged to be shifted by one chip in the X-axis direction.

The internal electrode pattern on the second ceramic sheet is formed in a similar manner to the internal electrode pattern on the first ceramic sheet. However, in the second ceramic sheet, an internal electrode pattern of a row corresponding to the first row of the first ceramic sheet extends across another facing second cutting line, and an internal electrode pattern of a row corresponding to the second row of the first ceramic sheet extends across one facing second cutting line. That is, the internal electrode pattern on the second ceramic sheet is formed to be shifted from the internal electrode pattern on the first ceramic sheet by one chip in the X-axis direction or the Y-axis direction.

The non-electrode formation regions are a region where no internal electrode pattern is formed on the ceramic sheet. In the first ceramic sheet, the non-electrode formation regions have a plurality of band regions extending along the second cutting lines between the internal electrode patterns adjacent to each other in the X-axis direction and a plurality of band regions extending along the first cutting lines between the internal electrode patterns adjacent to each other in the Y-axis direction. The non-electrode formation regions are formed in a lattice shape in which those band regions intersect each other as a whole.

Note that the non-electrode formation regions arranged in the X-axis direction correspond to the non-electrode formation regions 20A in the internal electrode lead-out region 50 described above. Further, the non-electrode formation regions arranged in the Y-axis direction correspond to the step regions 20C in the margin region 60.

The non-electrode formation regions on the second ceramic sheet are similarly formed.

The internal electrode patterns having a predetermined thickness are formed on the ceramic sheet. The thickness of the internal electrode patterns is an average thickness of the internal electrode patterns and can be determined as, for example, an average value of thicknesses measured at a plurality of parts in a similar manner to the average thickness of the ceramic layers 11.

On the non-electrode formation region, a space portion interposed between adjacent first internal electrode pattern and second internal electrode pattern is formed. The space portion is a space region having a thickness facing the non-electrode formation region. That is, the space portion has a volume obtained by multiplying the area of the non-electrode formation region by the thickness. The space portion corresponds to a gap in the laminated ceramic capacitor 100.

### (Step S2: Formation of Dielectric Pattern)

In step S2, a dielectric pattern is formed on the non-electrode formation region around the first internal electrode pattern in the first ceramic sheet and on the non-electrode formation region around the second internal electrode pattern in the second ceramic sheet.

The dielectric pattern can be formed by applying a ceramic paste to the non-electrode formation region of the ceramic sheet. The ceramic paste only needs to contain dielectric ceramics as a main component, but by using a dielectric ceramic similar to that of the ceramic sheet, the internal stress during firing is suppressed. For example, screen printing or gravure printing can be used for applying the ceramic paste.

In the present embodiment, the dielectric pattern is formed to occupy 40% or more and 100% or less of the space portion. That is, the dielectric pattern has a volume of 40% or more and 100% or less of the volume of the space portion obtained by multiplying the thickness of the internal electrode pattern by the area of the non-electrode formation region.

The average thickness of the dielectric patterns only needs to be equal to or less than the thickness of the space portion and may be, for example, up to 100% when the thickness is 100%. The average thickness of the dielectric patterns can be an average value when measured in a similar manner to the thickness of the internal electrode pattern.

The ceramic sheet may have a gap in which no dielectric pattern is formed around the internal electrode patterns. By providing a gap between the internal electrode pattern and the dielectric pattern, it is possible to prevent the dielectric pattern from being formed on the internal electrode pattern.

### (Step S3: Lamination)

In step S3, a laminated sheet is fabricated by laminating the ceramic sheets prepared in steps S1 and S2 and a third ceramic sheet. The third ceramic sheet is a ceramic sheet on which no internal electrode pattern or dielectric pattern is formed.

The laminated sheet includes an electrode laminated sheet in which the first ceramic sheet and the second ceramic sheet are alternately laminated in the Z-axis direction and two cover laminated sheets in which only the third ceramic sheets are laminated. The two cover laminated sheets are provided on upper and lower surfaces of the electrode laminated sheet in the Z-axis direction. The electrode laminated sheet corresponds to the laminated portion 20 after firing. The cover laminated sheets correspond to the cover portions 30 after firing.

The number of laminated ceramic sheets in the electrode laminated sheet is adjusted to obtain a desired volume and height dimension after firing. The number of laminated third ceramic sheets in the cover laminated sheet is not limited and is appropriately adjusted.

The laminated sheet is integrated by pressure-bonding the first ceramic sheet, the second ceramic sheet, and the third ceramic sheet. For pressure bonding of the ceramic sheets, for example, isostatic pressing, uniaxial pressing, or the like may be used. This makes it possible to densify the laminated sheet.

In the method for manufacturing the laminated ceramic electronic component according to the first embodiment, in step S3, a central region of an unfired cover portion corresponding to the central region 30A of the cover portion 30 is formed by arranging a fourth ceramic sheet between the third ceramic sheets. The fourth ceramic sheet is a ceramic sheet on which no internal electrode pattern or dielectric pattern is formed.

In the present disclosure, a peripheral edge region of the unfired cover portion corresponding to the peripheral edge region 30B of the cover portion 30 is formed by only the plurality of third ceramic sheets. That is, the fourth ceramic sheet is not arranged between the third ceramic sheets in the peripheral edge region of the unfired cover portion.

The third ceramic sheet is an example of a ceramic sheet for forming a cover portion in the laminated ceramic electronic component of the present disclosure. The fourth ceramic sheet is an example of another ceramic sheet for forming a cover portion in the laminated ceramic electronic component of the present disclosure.

### (Step S4: Cutting)

In step S4, the laminated sheet obtained in step S3 is cut along the first cutting lines and the second cutting lines, thereby fabricating unfired ceramic bodies.

The unfired ceramic body has two end surfaces facing in the X-axis direction, two side surfaces facing in the Y-axis direction, and two principal surfaces facing in the Z-axis direction. A cut portion of the electrode laminated sheet is configured as an unfired laminated portion. A cut portion of the cover laminated sheet is configured as an unfired cover portion.

A flat region is formed on the principal surface of the unfired ceramic body. The width dimension of the flat region in the Y-axis direction can be 60% or more and less than 100% of the width dimension of the unfired ceramic body. The unfired ceramic body may be chamfered by barrel polishing or the like after cutting. In that case, chamfering is performed such that the width dimension of the flat region falls within the above range.

### (Step S5: Firing)

In step S5, the unfired ceramic body obtained in step S4 is sintered, thereby fabricating the ceramic body 10 in FIGS. 1 to 3. That is, in step S5, the unfired laminated portion becomes the laminated portion 20, and the unfired cover portion becomes the cover portion 30. Firing can be performed, for example, in a reducing atmosphere or in a hypoxic atmosphere.

### (Step S6: Formation of External Electrode)

In step S6, the external electrodes 70 (first external electrode 71 and second external electrode 72) are formed on the ceramic body 10 obtained in step S5, thereby fabricating the laminated ceramic capacitor 100 in FIGS. 1 to 3.

In step S6, first, an unfired electrode material is applied to cover one end surface of the ceramic body 10 in the X-axis direction, and an unfired electrode material is applied to cover the other end surface of the ceramic body 10 in the X-axis direction. The unfired electrode material applied to the ceramic body 10 is subjected to, for example, baking treatment in a reducing atmosphere or a hypoxic atmosphere, thereby forming a base film on the ceramic body 10. Then, an interlayer film and a surface film are formed on the base film baked on the ceramic body 10 by plating treatment such as electrolytic plating, and thus the external electrodes 71 and 72 are completed.

Part of the processing in step S6 described above may be performed before step S5. For example, before step S5, the unfired electrode material may be applied to both the end surfaces of the unfired ceramic body in the X-axis direction, and in step S5, the base layers of the external electrodes 71 and 72 may be formed by baking the unfired electrode material at the same time as firing the unfired ceramic body. Alternatively, the unfired electrode material may be applied to the ceramic body 10 subjected to binder removal treatment, and those may be fired simultaneously.

The ceramic body 10 thus manufactured has a flat region as shown in FIGS. 1 to 3. The flat region is formed by forming the dielectric pattern occupying 40% or more and 80% or less of the space portion in step S2.

If the dielectric pattern is not formed, there is a difference in the height dimension in the Z-axis direction between the capacitance forming portion in which the internal electrode patterns are laminated and the margin region portion in which the non-electrode formation regions are laminated due to the thickness of the internal electrode patterns. Further, the larger the number of laminated ceramic sheets, that is, the larger the height dimension of the laminated ceramic capacitor, the larger the difference in height in the Z-axis direction between the above portions. Therefore, in the ceramic body in which the laminated ceramic sheets are pressure-bonded and cut, the height dimension gradually increases from the peripheral edge portion in the Y-axis direction toward the central region in the Y-axis direction, and the principal surface is formed in a curved surface shape protruding in the Z-axis direction.

The laminated ceramic capacitor in FIGS. 1 to 3 is fabricated by the method for manufacturing a laminated ceramic electronic component according to the present disclosure.

Further, the laminated ceramic electronic component according to the first embodiment is not limited to the laminated ceramic capacitor and is applicable to all laminated ceramic electronic components in which a part of a laminated body constitutes a pair of margin regions. Examples of the laminated ceramic electronic component to which the present disclosure is applicable include not only the laminated ceramic capacitor, but also a chip varistor, a chip thermistor, and a laminated inductor.

### EXAMPLES AND COMPARATIVE EXAMPLES

As examples and comparative examples of the present embodiment, samples of the laminated ceramic capacitor 100 were fabricated on the basis of the above manufacturing method. The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### [Porosity]

The porosity of the central region 30A of the cover portion 30 was confirmed as a high density area, and the porosity of the peripheral edge region 30B of the cover portion 30 was confirmed as a low density area. For the porosity, the cross sections of the central region 30A and the peripheral edge region 30B of the cover portion 30 were imaged at 2000 to 5000 times magnification by a scanning electron microscope (SEM). Five parts of the cross sections of the central region 30A and the peripheral edge region 30B were imaged, cross-sectional areas of pores appearing in the captured images were measured, each average value of the cross-sectional areas of the pores was calculated from the cross-sectional areas of the pores in the plurality of images, and the porosity in the central region 30A and the porosity in the peripheral edge region 30B were calculated from a ratio of the average value to the cross-sectional area.

### [Vickers Hardness and Vickers Hardness Ratio]

By using a Vickers hardness meter (Micro Vickers MMT-X manufactured by Matsuzawa Co., Ltd.), the Vickers hardness of the central region 30A of the cover portion 30 was measured as the high density area, and the Vickers hardness of the peripheral edge region 30B of the cover portion 30 was measured as the low density area. Further, a Vickers hardness ratio between the obtained high density area and low density area was calculated.

### [Crack Progress in Active Area]

After the bending stress was applied, the presence or absence of crack progress in an active area of the sample corresponding to the capacitance forming portion of the laminated ceramic capacitor was confirmed by using an optical microscope (upright microscope BX53M manufactured by Olympus Corporation). A state in which the bending stress was applied to the sample means a state in which an amount of deflection of a sample soldered to a glass epoxy substrate conforming to JIS C 6484 was 5 mm when the sample was pressed at a speed of 0.5 mm/sec until the amount of deflection reached 2 mm. In a case where the crack progress in the active area was not confirmed, the crack progress was evaluated as good, whereas in a case where the crack progress in the active area was confirmed, the crack progress was evaluated as not good.

### Example 1

The porosity of the high density area was 2.0%, the Vickers hardness was 1000 HV (N/mm²), the porosity of the low density area was 4.9%, a ratio of the low density area was 900 HV (N/mm²), the Vickers hardness ratio between the high density area and the low density area was 1.1, and the crack progress in the active area was good. The results are shown in Table 1.

### Example 2

The porosity of the high density area was 0.7%, the Vickers hardness was 1600 HV (N/mm²), the porosity of the low density area was 0.9%, the ratio of the low density area was 1300 HV (N/mm²), the Vickers hardness ratio between the high density area and the low density area was 1.2, and the crack progress in the active area was good. The results are shown in Table 1.

### Example 3

The porosity of the high density area was 0.8%, the Vickers hardness was 1200 HV (N/mm²), the porosity of the low density area was 1.0%, the ratio of the low density area was 1000 HV (N/mm²), the Vickers hardness ratio between the high density area and the low density area was 1.2, and the crack progress in the active area was good. The results are shown in Table 1.

### Comparative Example 1

The porosity of the high density area was 4.8%, the Vickers hardness was 550 HV (N/mm²), the porosity of the low density area was 4.8%, the ratio of the low density area was 550 HV (N/mm²), the Vickers hardness ratio between the high density area and the low density area was 1.0, and the crack progress in the active area was not good. The results are shown in Table 1.

### Comparative Example 2

The porosity of the high density area was 3.8%, the Vickers hardness was 800 HV (N/mm²), the porosity of the low density area was 4.2%, the ratio of the low density area was 600 HV (N/mm²), the Vickers hardness ratio between the high density area and the low density area was 1.3, and the crack progress in the active area was not good. The results are shown in Table 1.

### Comparative Example 3

The porosity of the high density area was 0.8%, the Vickers hardness was 1250 HV (N/mm²), the porosity of the low density area was 0.2%, the ratio of the low density area was 1600 HV (N/mm²), the Vickers hardness ratio between the high density area and the low density area was 0.8, and the crack progress in the active area was not good. The results are shown in Table 1.

### Comparative Example 4

The porosity of the high density area was 5.0%, the Vickers hardness was 500 HV (N/mm²), the porosity of the low density area was 5.3%, the ratio of the low density area was 400 HV (N/mm²), the Vickers hardness ratio between the high density area and the low density area was 1.3, and the crack progress in the active area was not good. The results are shown in Table 1.

TABLE 1

| | | | | | Vickers | |
|---|---|---|---|---|---|---|
| | | | | | hardness ratio | |
| | High density area | | Low density area | | between high | |
| | | Vickers | | Vickers | density area | |
| | | hardness HV | | hardness HV | and low | Crack progress |
| | Porosity (%) | (N/mm²) | Porosity (%) | (N/mm²) | density area | in active area |
| Example 1 | 2.0% | 1000 | 4.9% | 900 | 1.1 | Good |
| Example 2 | 0.7% | 1600 | 0.9% | 1300 | 1.2 | Good |
| Example 3 | 0.8% | 1200 | 1.0% | 1000 | 1.2 | Good |
| Comparative | 4.8% | 550 | 4.8% | 550 | 1.0 | Not good |
| Example 1 | | | | | | |
| Comparative | 3.8% | 800 | 4.2% | 600 | 1.3 | Not good |
| Example 2 | | | | | | |
| Comparative | 0.8% | 1250 | 0.2% | 1600 | 0.8 | Not good |
| Example 3 | | | | | | |
| Comparative | 5.0% | 500 | 5.3% | 400 | 1.3 | Not good |
| Example 4 | | | | | | |

From Table 1, in Examples 1 to 3, the crack progress in the active area was not confirmed in the samples in which the porosity of the peripheral edge region 30B of the cover portion 30 was larger than the porosity of the central region 30A of the cover portion 30 and the ratio between the Vickers hardness of the central region 30A of the cover portion 30 and the Vickers hardness of the peripheral edge region 30B of the cover portion 30 was 1.0 or more. From this result, it can be seen that the laminated ceramic electronic component according to the first embodiment has high bending resistance.

### Second Embodiment

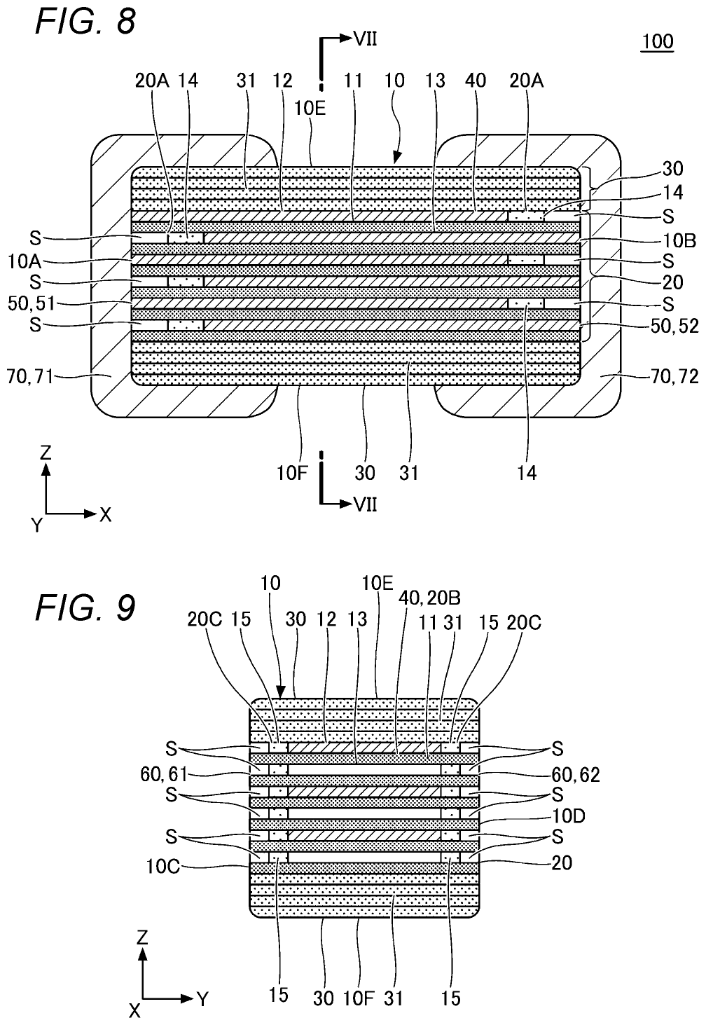

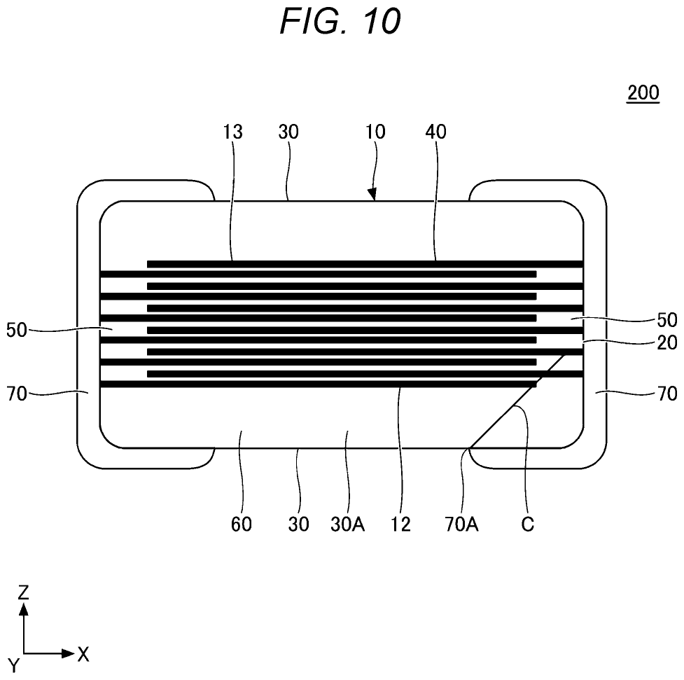

FIG. 8 is a cross-sectional view of a laminated ceramic capacitor as an example of a laminated ceramic electronic component according to a second embodiment and is a view corresponding to FIG. 2. FIG. 9 is a cross-sectional view of the laminated ceramic capacitor as an example of the laminated ceramic electronic component according to the second embodiment and is a view corresponding to FIG. 3. In FIGS. 8 and 9, reference signs the same as or corresponding to the reference signs in FIGS. 2 and 3 will be given to portions common to those in the first embodiment, and description thereof will be omitted.

In the laminated ceramic capacitor 100 in FIGS. 8 and 9, the third density D3 that is the density of the internal electrode lead-out region 50 and/or the fourth density D4 of the margin region 60 are/is smaller than the first density D1 that is the density of the central region 30A of the cover portion 30.

FIG. 10 shows an effect of the laminated ceramic electronic component according to the second embodiment. Also in the laminated ceramic capacitor 100 of the present disclosure, in a case where the bending stress is generated, a bending crack C tends to occur from the boundary 70A between the cover portion 30 and the end of the external electrode 70.

Meanwhile, because the third density D3 and/or the fourth density D4 are/is smaller than the first density D1 in the laminated ceramic capacitor 100 of the present disclosure, the bending crack C tends to be led to the internal electrode lead-out region 50 and/or the margin region 60 having a smaller density. That is, even if the bending crack C occurs in the laminated ceramic capacitor 100, the bending crack C does not easily reach the capacitance forming portion 40 that is a capacitance active area.

When the bending crack C progresses in the internal electrode lead-out region 50 where the lead-out portions of the internal electrodes 12 and 13 are arranged, the capacitance of the laminated ceramic capacitor 100 decreases, but by preventing the progress of the bending crack C in the capacitance forming portion 40 that is the active area, a fatal structural defect to the capacitance portion of the laminated ceramic capacitor 100 can be prevented.

In the laminated ceramic capacitor 100 of the present disclosure, the porosity of the central region 30A of the cover portion 30 is less than 2.0%, whereas the porosity of the internal electrode lead-out region 50 and/or the margin region 60 is 2.0% or more. Note that the porosity is calculated in a similar manner to the porosity of the central region 30A and the like of the cover portion 30 described above.

In the laminated ceramic capacitor 100 of the present disclosure, the porosity of the central region 30A of the cover portion 30 is less than 2.0%, and the porosity of the internal electrode lead-out region 50 and/or the margin region 60 is 2.0% or more, and thus the third density D3 and/or the fourth density D4 can be made smaller than the first density D1 as described above.

In the second embodiment, the third density D3 and/or the fourth density D4 are/is smaller than the second density D2. Specifically, the porosity of the peripheral edge region 30B of the cover portion 30 is less than 2.0%, whereas the porosity of the internal electrode lead-out region 50 and/or the margin region 60 is 2.0% or more. That is, in the second embodiment, the porosity of the internal electrode lead-out region 50 and/or the margin region 60 is smaller than the porosity of the peripheral edge region 30B of the cover portion 30.

In the laminated ceramic capacitor 100 of the present disclosure, the porosity of the internal electrode lead-out region 50 and/or the margin region 60 is smaller than the porosity of the peripheral edge region 30B of the cover portion 30, and thus the third density D3 and/or the fourth density D4 are/is smaller than the second density D2. Therefore, the bending crack C tends to progress in the internal electrode lead-out region 50 and/or the margin region 60, which makes it possible to reliably prevent the progress of the bending crack C in the capacitance forming portion 40 that is the active area.

Further, in the present disclosure, a ratio between the Vickers hardness of the central region 30A of the cover portion 30 and the Vickers hardness of the internal electrode lead-out region 50 and/or the margin region 60 is 1.0 or more.

In the laminated ceramic capacitor 100 of the present disclosure, as described above, the third density D3 and/or the fourth density D4 can be made smaller than the first density D1 also when the ratio between the Vickers hardness of the central region 30A of the cover portion 30 and the Vickers hardness of the internal electrode lead-out region 50 and/or the margin region 60 is 1.0 or more.

In the laminated ceramic capacitor 100 of the present disclosure, the ceramic layer 14 is not arranged in a part of the non-electrode formation region 20A in the internal electrode lead-out region 50. That is, as shown in FIG. 8, in the internal electrode lead-out region 50, a gap S is between the ceramic layer 14 in the non-electrode formation region 20A and the external electrodes 70. The ceramic layer 14 here is an example of the second ceramic layer that is not formed in a part of the non-electrode formation region 20A in the laminated ceramic electronic component according to the present disclosure.

Because the ceramic layer 14 is not arranged in a part of the non-electrode formation region 20A as described above, the third density D3 of the internal electrode lead-out region 50 can be made smaller than the first density D1 of the central region 30A of the cover portion 30.

In a case where the ceramic layer 14 is not arranged in a part of the non-electrode formation region 20A in the internal electrode lead-out region 50, the ceramic layer 14 may be arranged on the capacitance forming portion 40 side as shown in FIG. 8. That is, the gap S may be on the side opposite to the capacitance forming portion 40 side when the ceramic layer 14 is in the non-electrode formation region 20A.

By arranging the ceramic layer 14 on the capacitance forming portion 40 side in this manner, the bending crack C that has progressed in the internal electrode lead-out region 50 tends to be led to the side away from the capacitance forming portion 40, which makes it possible to prevent a fatal structural defect to the capacitance portion of the laminated ceramic capacitor 100.

In the laminated ceramic capacitor 100 of the present disclosure, the ceramic layer 15 is not arranged in a part of the step region 20C in the margin region 60. That is, as shown in FIG. 9, a gap S is between the ceramic layer in the step region 20C and the margin region 60. The ceramic layer 15 is an example of a fifth ceramic layer in the laminated ceramic electronic component of the present disclosure.

Because the ceramic layer 15 is not arranged in a part of the step region 20C as described above, the fourth density D4 that is the density of the margin region 60 can be made smaller than the first density D1 that is the density of the central region 30A of the cover portion 30.

In a case where the ceramic layer 15 is not arranged in a part of the step region 20C in the margin region 60, the ceramic layer 15 is may be arranged on the capacitance forming portion 40 side as shown in FIG. 9. That is, the gap S may be on the side opposite to the capacitance forming portion 40 side in a state in which the ceramic layer 15 is arranged in the step region 20C.

By arranging the ceramic layer 15 on the capacitance forming portion 40 side in this manner, the bending crack C that has progressed in the margin region 60 tends to be led to the side away from the capacitance forming portion 40, which makes it possible to prevent a fatal structural defect to the capacitance portion of the laminated ceramic capacitor 100.

### [Method for Manufacturing Laminated Ceramic Electronic Component of Second Embodiment]

Hereinafter, a method for manufacturing the laminated ceramic electronic component according to the second embodiment will be described. Reference signs the same as or corresponding to the reference signs in FIG. 7 will be given to parts common to those in the method for manufacturing the laminated ceramic electronic component according to the first embodiment, and description thereof will be omitted.

In the method for manufacturing the laminated ceramic electronic component according to the second embodiment, in step S3, a dielectric pattern is formed in a part of the non-electrode formation region around the first internal electrode pattern on the first ceramic sheet. Further, a dielectric pattern is formed on a part of the non-electrode formation region around the second internal electrode pattern on the second ceramic sheet. That is, a portion in which the dielectric pattern is not formed is provided in the non-electrode formation region such that a space portion is formed while being interposed between adjacent first and second internal electrode patterns.

Further, an unfired internal electrode lead-out region corresponding to the internal electrode lead-out region 50 is formed by laminating the first ceramic sheet on which the first internal electrode pattern, the dielectric pattern, and the non-electrode formation region where the dielectric pattern is not formed are formed and the second ceramic sheet on which the second internal electrode pattern, the dielectric pattern, and the non-electrode formation region where the dielectric pattern is not formed are formed. Therefore, in the unfired internal electrode lead-out region, a space portion is formed in a portion where the dielectric pattern is not formed on the non-electrode formation region.

The first ceramic sheet and the second ceramic sheet are examples of a ceramic sheet on which an internal electrode pattern is formed in the laminated ceramic electronic component of the present disclosure. The dielectric pattern is an example of a ceramic pattern formed in a part of the non-electrode formation region in the laminated ceramic electronic component of the present disclosure. The space portion formed in the non-electrode formation region here corresponds to the non-electrode formation region 20A in the internal electrode lead-out region 50 after firing.

In the method for manufacturing the laminated ceramic electronic component according to the second embodiment, in step S3, after the dielectric pattern is formed in a part of the non-electrode formation region around the internal electrode pattern on the ceramic sheet as described above, an unfired margin region corresponding to the margin region 60 is formed by laminating the first ceramic sheet on which the first internal electrode pattern, the dielectric pattern, and the non-electrode formation region where the dielectric pattern is not formed are formed and the second ceramic sheet on which the second internal electrode pattern, the dielectric pattern, and the non-electrode formation region where the dielectric pattern is not formed are formed. Therefore, in the unfired margin region, a space portion is formed in a portion in which the dielectric pattern is not formed on the non-electrode formation region corresponding to the step region 20C in the fired margin region 60.

The dielectric pattern is an example of a ceramic pattern formed in a part of the step region in the laminated ceramic electronic component of the present disclosure. The space portion formed in the non-electrode formation region here corresponds to the step region 20C in the margin region 60 after firing.

The laminated ceramic capacitor as in FIGS. 8 and 9 is fabricated by the method for manufacturing a laminated ceramic electronic component according to the present disclosure.

Further, the laminated ceramic electronic component according to the second embodiment is not limited to the laminated ceramic capacitor and is applicable to all laminated ceramic electronic components in which a part of a laminated body constitutes a pair of margin regions. Examples of the laminated ceramic electronic component to which the present disclosure is applicable include not only the laminated ceramic capacitor, but also a chip varistor, a chip thermistor, and a laminated inductor.

Although the embodiment of the present disclosure has been described above, the present disclosure is not limited to a specific embodiment, and various modifications and changes can be made within the scope of the invention described in the claims.

What is claimed is:

1. A laminated ceramic electronic component comprising:
a laminated portion including
a plurality of first ceramic layers laminated in a first direction,
a plurality of internal electrodes alternately led out and arranged in a second direction orthogonal to the first direction,
a non-electrode formation region having no internal electrode between the plurality of first ceramic layers, and
a plurality of second ceramic layers laminated in the non-electrode formation region between the plurality of first ceramic layers;
a pair of cover portions facing each other in the first direction with the laminated portion between the pair of cover portions along the first direction; and
a pair of external electrodes connected to the plurality of internal electrodes and facing each other in the second direction, wherein:
the laminated portion has
a capacitance forming portion in which the plurality of internal electrodes is laminated in the first direction via the first ceramic layers,
a pair of internal electrode lead-out regions between the pair of cover portions, wherein
the first ceramic layers, the internal electrodes, the second ceramic layers and the pair of internal electrode lead-out regions are laminated in the first direction,
the pair of internal electrode lead-out regions face each other in the second direction,
the capacitance forming portion is between the internal electrode lead-out regions along the second direction and a pair of margin regions between the pair of cover portions, in which the first ceramic layers and the second ceramic layers are alternately laminated in the first direction,
the pair of margin regions facing each other in a third direction orthogonal to the first direction and the second direction, and
the capacitance forming portion and the internal electrode lead-out regions are between the margin regions along the third direction; and
each cover portion of the pair of cover portions has
a central region having a first density adjacent to the capacitance forming portion, and
a peripheral edge region having second density surrounding the central region, wherein
the internal electrode lead-out region has a third density and the margin region has a fourth density, and
at least one of the second density, the third density, and the fourth density is less than the first density.

2. The laminated ceramic electronic component according to claim 1, wherein
porosity of the central region of each of the pair of cover portions is less than 2.0%; and
porosity of the peripheral edge region of each cover portion of the pair of cover portions, porosity of each internal electrode lead-out regions of pair of internal electrode lead-out region, and porosity of each margin region of the pair of margin regions are each 2.0% or more.

3. The laminated ceramic electronic component according to claim 2, wherein
the porosity of the peripheral edge region is smaller than the porosity of the internal electrode lead-out region and/or the margin region.

4. The laminated ceramic electronic component according to claim 2, wherein
the porosity of the internal electrode lead-out region and/or the margin region is smaller than the porosity of the peripheral edge region.

5. The laminated ceramic electronic component according to claim 1, wherein
a ratio between a Vickers hardness of the central region of each cover portion of the pair of cover portions and a Vickers hardness of at least one of the peripheral edge region of each cover portion of the pair of cover portions, the internal electrode lead-out region, or the margin region is 1.0 or more.

6. The laminated ceramic electronic component according to claim 1, wherein
the second density, the third density, and the fourth density region are each less than the first density.

7. The laminated ceramic electronic component according to claim 1, wherein
the second density is smaller than the third density and/or the fourth density.

8. The laminated ceramic electronic component according to claim 1, wherein
the third density and/or the fourth density is smaller than the second density.

9. The laminated ceramic electronic component according to claim 1, wherein
the central region of each cover portion of the pair of cover portions includes at least two third ceramic layers and a fourth ceramic layer interposed therebetween, and
the peripheral edge region of each cover portion has less material along the first direction than the central region.

10. The laminated ceramic electronic component according to claim 1, wherein
the central region of each cover portion of the pair of cover portions and the peripheral edge region of each cover portion of the pair of cover portions have a same structure.

11. The laminated ceramic electronic component according to claim 1, wherein
there is a gap between the plurality of second ceramic layers and the pair of internal electrode lead-out regions along the second direction.

12. The laminated ceramic electronic component according to claim 1, wherein
there is a gap between the plurality of second ceramic layers and the pair of margin regions along the third direction.

13. A method for manufacturing a laminated ceramic electronic component including: a laminated portion, including a plurality of first ceramic layers laminated in a first direction, a plurality of internal electrodes alternately led out and arranged in a second direction orthogonal to the first direction, a non-electrode formation region where no internal electrode between the plurality of first ceramic layers, and a plurality of second ceramic layers laminated in the non-electrode formation region between the plurality of first ceramic layers, a pair of cover portions facing each other in the first direction, wherein the laminated portion is between the cover portions, and a pair of external electrodes connected to the plurality of internal electrodes and facing each other in the second direction,
wherein the laminated portion has a capacitance forming portion in which the plurality of internal electrodes is laminated in the first direction on a plurality of the first ceramic layers, a pair of internal electrode lead-out regions between the pair of cover portions, the first ceramic layers, the internal electrodes, the second ceramic layers, and the pair of internal electrode lead-out regions are laminated in the first direction, the pair of internal electrode lead-out regions face each other in the second direction with the capacitance forming portion between the internal electrode lead-out regions, and a pair of margin regions between the pair of cover portions, in which the first ceramic layers and the second ceramic layers are alternately laminated in the first direction, the pair of margin regions facing each other in a third direction orthogonal to the first direction and the second direction with the capacitance forming portion and the internal electrode lead-out regions interposed between the margin regions, and
wherein each cover portion of the pair of cover portions has a central region adjacent to the capacitance forming portion, and a peripheral edge region surrounding the central region, and
wherein a density of the central region of the cover portion is defined as a first density, a density of the peripheral edge region of the cover portion is defined as a second density, a density of the internal electrode lead-out region is defined as a third density, and a density of the margin region is defined as a fourth density, at least one of the second density, the third density, or the fourth density is smaller than the first density, the method comprising:
forming the cover portion by laminating a plurality of first ceramic sheets;
forming the central region of the cover portion by arranging a second ceramic sheet between the plurality of first ceramic sheets; and
forming the peripheral edge region of the cover portion by using only the plurality of first ceramic sheets.

14. The method for manufacturing a laminated ceramic electronic component according to claim 13, wherein
the second density is smaller than the third density and/or the fourth density.

15. The method for manufacturing a laminated ceramic electronic component according to claim 13, wherein a ratio between a Vickers hardness of the central region of each cover portion of the pair of cover portions and a Vickers hardness of at least one of the peripheral edge region of each cover portion of the pair of cover portions, the internal electrode lead-out region, or the margin region is 1.0 or more.

16. A method for manufacturing a laminated ceramic electronic component including: a laminated portion including a plurality of first ceramic layers laminated in a first direction, a plurality of internal electrodes alternately led out and arranged in a second direction orthogonal to the first direction, a non-electrode formation region with no internal electrode between the plurality of first ceramic layers, and a plurality of second ceramic layers laminated in the non-electrode formation region between the plurality of first ceramic layers; a pair of cover portions facing each other in the first direction with the laminated portion interposed between the cover portions; and a pair of external electrodes connected to the plurality of internal electrodes and facing each other in the second direction,
wherein the laminated portion has a capacitance forming portion in which the plurality of internal electrodes is laminated in the first direction via the first ceramic layers, a pair of internal electrode lead-out regions between the pair of cover portions, in which the first ceramic layers, the internal electrodes, the second ceramic layers, and the pair of internal electrode lead-out regions are laminated in the first direction, the internal electrode lead-out regions face each other in the second direction with the capacitance forming portion between the internal electrode lead-out regions along the second direction, and a pair of margin regions between the pair of cover portions, in which the first ceramic layers and the second ceramic layers are alternately laminated in the first direction, the pair of margin regions facing each other in a third direction orthogonal to the first direction and the second direction with the capacitance forming portion and the internal electrode lead-out regions interposed between the margin regions,
wherein each cover portion of the pair of cover portions has a central region adjacent to the capacitance forming portion, and a peripheral edge region surrounding the central region, and
wherein a density of the central region of the cover portion is defined as a first density, a density of the peripheral edge region of the cover portion is defined as a second density, a density of the internal electrode lead-out region is defined as a third density, and a density of the margin region is defined as a fourth density, at least one of the second density, the third density, or the fourth density is smaller than the first density, the method comprising:
forming an internal electrode pattern on a plurality of ceramic sheets;
forming a ceramic pattern in a part of the non-electrode formation region around the internal electrode pattern on the ceramic sheets; and
forming the internal electrode lead-out region by laminating the ceramic sheets in which the internal electrode pattern is formed and the non-electrode formation region where the ceramic pattern is not formed.

17. The method for manufacturing a laminated ceramic electronic component according to claim 16, wherein
the third density and/or the fourth density are/is smaller than the second density.

18. A method for manufacturing a laminated ceramic electronic component including: a laminated portion including a plurality of first ceramic layers laminated in a first direction, a plurality of internal electrodes alternately led out and arranged in a second direction orthogonal to the first direction, a non-electrode formation region where no internal electrode between the plurality of first ceramic layers, and a plurality of second ceramic layers laminated in the non-electrode formation region between the plurality of first ceramic layers; a pair of cover portions facing each other in the first direction with the laminated portion interposed between the cover portions; and a pair of external electrodes connected to the plurality of internal electrodes and facing each other in the second direction,
wherein the laminated portion has a capacitance forming portion in which the plurality of internal electrodes is laminated in the first direction via the first ceramic layers, a pair of internal electrode lead-out regions between the pair of cover portions, in which the first ceramic layers, the internal electrodes, the second ceramic layers, and the pair of internal electrode lead-out regions are laminated in the first direction, the internal electrode lead-out regions face each other in the second direction with the capacitance forming portion interposed between the internal electrode lead-out regions, and a pair of margin regions between the pair of cover portions, the pair of margin regions face each other in a third direction orthogonal to the first direction and the second direction with the capacitance forming portion and the internal electrode lead-out regions interposed between the margin regions,
wherein each cover portion of the pair cover portions has a central region adjacent to the capacitance forming portion, and a peripheral edge region surrounding the central region, and
wherein a density of the central region of the cover portion is defined as a first density, a density of the peripheral edge region of the cover portion is defined as a second density, a density of the internal electrode lead-out region is defined as a third density, and a density of the margin region is defined as a fourth density, at least one of the second density, the third density, or the fourth density is smaller than the first density, the method comprising:
forming an internal electrode pattern on a plurality of ceramic sheets;
forming a ceramic pattern in a part of a step region that forms a step with the internal electrode pattern on the ceramic sheets; and
forming the margin region by laminating the ceramic sheets in which the internal electrode pattern is formed and the step region where the ceramic pattern is not formed.

19. The method for manufacturing a laminated ceramic electronic component according to claim 18, wherein
the third density and/or the fourth density are/is smaller than the second density.
